(19) United States
(12) Patent Application Publication
(10) Pub. No.: US 2026/0073826 A1
(43) Pub. Date: Mar. 12, 2026

(54) DISPLAY PANEL, METHOD FOR DRIVING DISPLAY PANEL, AND DISPLAY DEVICE

(71) Applicant: Xiamen Tianma Display Technology Co., Ltd., Xiamen (CN)

(72) Inventors: Wencui XU, Xiamen (CN); Xiangwen Ma, Xiamen (CN); Fengwei Xu, Xiamen (CN)

(73) Assignee: Xiamen Tianma Display Technology Co., Ltd., Xiamen (CN)

(21) Appl. No.: 18/951,689

(22) Filed: Nov. 19, 2024

(30) Foreign Application Priority Data
Sep. 9, 2024 (CN) 202411258937.9

(51) Int. Cl. G09G 3/20

(52) U.S. Cl. CPC G09G 3/20; G09G 2320/0219; G09G 2320/0247

(57) ABSTRACT

Embodiments of the present application provide a display panel and a method for driving it, and a display device, the display panel comprising: a display array, comprising a first and a second display area, picture refresh frequency of the first display area being less than that of the second display area; pixel circuits, comprising first pixel circuits to control display states of a first row display pixels in the second display area close to the first display area; a working process of the pixel circuits comprises reset, data writing and light-emitting stage, in first display frame, display pixels of the first display area enter data holding stage, display pixels of the second display area enter data writing stage, at first moment earlier than a start moment of data writing stage of the first pixel circuits in the first display frame, a first signal is provided to the data lines.

### CROSS-REFERENCE TO RELATED APPLICATION

The present application claims priority to Chinese Patent Application No. 202411258937.9 filed on September 9, 2024, and titled “DISPLAY PANEL, METHOD FOR DRIVING DISPLAY PANEL, AND DISPLAY DEVICE”, which is incorporated herein by reference in its entirety.

### TECHNICAL FIELD

The present application relates to the field of display technology, and in particular to a display panel and a method for driving a display panel, and a display device.

### BACKGROUND

With the continuous advancement of modern display technology, high refresh rate has become one of the important indicators for improving user visual experience. Especially in the field of games and professional image processing, high refresh rate can effectively reduce the smear and blur of dynamic images and enhance the smoothness and clarity of the images. However, in actual applications, we found that there are display anomalies in the boundary area between the high refresh area and the low refresh area of the display panel, which directly affects the display effect and user experience of the display panel.

### SUMMARY

In view of the above problems, the present application provides a display panel, a method for driving the display panel and a display device to alleviate the display abnormality in the boundary area between the high refresh area and the low refresh area of the display panel, thereby improving the display quality and user experience of the display panel. The specific solutions are as follows.

In a first aspect, embodiments of the present application provide a display panel, comprising:

a display array, comprising a first display area and a second display area arranged along a scanning direction, a picture refresh frequency of the first display area being less than a picture refresh frequency of the second display area;

a plurality of pixel circuits, corresponding to display pixels in the display array, one by one, to control display states of corresponding display pixels, the plurality of pixel circuits comprising a plurality of first pixel circuits configured to control display states of a first row of display pixels in the second display area close to the first display area;

a plurality of data lines and a plurality of power lines electrically connected with the plurality of pixel circuits, at least one of the plurality of data lines and at least one of the plurality power line having capacitance therebetween,

wherein a working process of the plurality of pixel circuits comprises a reset stage, a data writing stage and a light-emitting stage, in at least one first display frame, display pixels of the first display area enter a data holding stage, and display pixels of the second display area enter the data writing stage, at the first moment in the first display frame, a first signal is provided to the plurality of data lines, the first moment being earlier than a start moment of the data writing stage of the plurality of first pixel circuits.

In a second aspect, embodiments of the present application provide a display device comprising a display panel, the display panel comprising:

a display array, comprising a first display area and a second display area arranged along a scanning direction, a picture refresh frequency of the first display area being less than a picture refresh frequency of the second display area;

a plurality of pixel circuits, corresponding to display pixels in the display array, one by one, to control display states of corresponding display pixels, the plurality of pixel circuits comprising a plurality of first pixel circuits configured to control display states of a first row of display pixels in the second display area close to the first display area;

a plurality of data lines and a plurality of power lines electrically connected with the plurality of pixel circuits, at least one of the plurality of data lines and at least one of the plurality power line having capacitance therebetween,

wherein a working process of the plurality of pixel circuits comprises a reset stage, a data writing stage and a light-emitting stage, in at least one first display frame, display pixels of the first display area enter a data holding stage, and display pixels of the second display area enter the data writing stage, at the first moment in the first display frame, a first signal is provided to the plurality of data lines, the first moment being earlier than a start moment of the data writing stage of the plurality of first pixel circuits.

In a third aspect, embodiments of the present application provide method for driving a display panel, the display panel comprising:

a display array, comprising a first display area and a second display area arranged along a scanning direction, a picture refresh frequency of the first display area being less than a picture refresh frequency of the second display area;

a plurality of pixel circuits, corresponding to display pixels in the display array, one by one, to control display states of corresponding display pixels, the plurality of pixel circuits comprising a plurality of first pixel circuits configured to control display states of a first row of display pixels in the second display area close to the first display area;

a plurality of data lines and a plurality of power lines electrically connected with the plurality of pixel circuits, at least one of the plurality of data lines and at least one of the plurality power line having capacitance therebetween,

wherein a working process of the plurality of pixel circuits comprises a reset stage, a data writing stage and a light-emitting stage,

the method comprising:

in at least one first display frame, display pixels of the first display area entering a data holding stage, and display pixels of the second display area entering the data writing stage,

at the first moment in the first display frame, providing a first signal to the plurality of data lines, the first moment being earlier than a start moment of the data writing stage of the plurality of first pixel circuits.

### BRIEF DESCRIPTION OF THE DRAWINGS

Other features, objects and advantages of the present application will become more apparent with reference to the following detailed description in conjunction with the accompanying drawings. Throughout the accompanying drawings, the same or similar reference numerals represent the same or similar elements. It should be understood that the drawings are schematic and the originals and elements are not necessarily drawn to scale.

FIG. 1 is a schematic diagram showing a display panel comprising a low-frequency display area L and a high-frequency display area H;

FIG. 2 is a schematic diagram showing a jump in a signal on Source in a display panel affecting a voltage on a power signal line PVDD;

FIG. 3 is a schematic diagram showing relative positions of a data line DATA, a power signal line PVDD and an N1 node in a wiring design of a display panel;

FIG. 4 is a schematic structural diagram of a pixel circuit;

FIG. 5 is a schematic diagram of a display array in a display panel in an embodiment of the present application;

FIG. 6 is a schematic diagram of a pixel circuit in an embodiment of the present application;

FIG. 7 is a schematic diagram of a pixel circuit in another embodiment of the present application;

FIG. 8 is a schematic diagram of a pixel circuit in yet another embodiment of the present application;

FIG. 9 is a schematic diagram of a pixel circuit in yet another embodiment of the present application;

FIG. 10 is a timing diagram of the operation of a pixel circuit in a display panel in an embodiment of the present application;

FIG. 11 is a schematic diagram of the relative positions of the input timing of the first signal in the data line corresponding to the plurality of first pixel circuits and the data writing stage of the plurality of first pixel circuits in the display panel in an embodiment of the present application;

FIG. 12 is a schematic diagram of the relative positions of the input timing of the first signal in the data line corresponding to the plurality of first pixel circuits and the reset stage and the data writing stage of the plurality of first pixel circuits in the display panel in an embodiment of the present application;

FIG. 13 is a schematic diagram of the relative positions of the input timing of the first signal in the data line corresponding to the plurality of first pixel circuits and the data writing stage of the plurality of first pixel circuits in the display panel in another embodiment of the present application;

FIG. 14 is a schematic diagram of the relative positions of the input timing of the first signal in the data line corresponding to the plurality of first pixel circuits and the reset stage and the data writing stage of the plurality of first pixel circuits in the display panel in another embodiment of the present application;

FIG. 15 is a schematic structural diagram of a display panel in yet another embodiment of the present application;

FIG. 16 is a timing diagram of an input signal, a control signal, and an output signal of a first gating circuit when a display panel in an embodiment of the present application is working;

FIG. 17 is a timing diagram of first scanning signals corresponding to display pixels at different positions and a timing diagram of signals on data lines when the display panel provided in an embodiment of the present application is working;

FIG. 18 is a timing diagram of first scanning signals corresponding to display pixels at different positions and a timing diagram of signals on data lines when the display panel in another embodiment of the present application is working;

FIG. 19 is a schematic structural diagram of a display panel in yet another embodiment of the present application;

FIG. 20 is a schematic diagram of the relative positions of the input timing of the target data voltage signal in the data line corresponding to the plurality of first pixel circuits and the data writing stage of the plurality of first pixel circuits in the second display frame in a method for driving a display panel in an embodiment of the present application.

### DETAILED DESCRIPTION

The following will be combined with the drawings in the embodiments of the present application to clearly and completely describe embodiments in the present application. Obviously, the described embodiments are only part of the embodiments of the present application, not all of the embodiments. Based on the embodiments in the present application, all other embodiments obtained by the skilled in the art without making creative work are within the scope of protection of this application.

It is obvious to those skilled in the art that various modifications and changes can be made in this application without departing from the spirit or scope of this application. Therefore, this application is intended to cover modifications and changes of this application that fall within the scope of the corresponding claims (technical solutions claimed for protection) and their equivalents. It should be noted that the implementations provided in the embodiments of this application can be combined with each other without contradiction.

In order to make the above-mentioned objects, features and advantages of the present application more obvious and easy to understand, the present application is further described in detail below in conjunction with the accompanying drawings and specific embodiments.

As described in the background, there is a display anomaly in the boundary area between the high refresh area and the low refresh area of the display panel, which directly affects the display effect and user experience of the display panel.

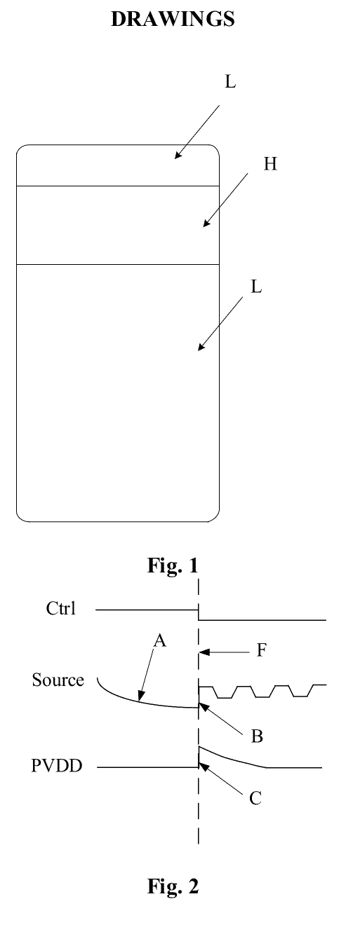

As shown in FIG. 1, the display panel comprises a low-frequency display area L and a high-frequency display area H, wherein the refresh frequencies of the low-frequency display area L and the high-frequency display area H are different, and the data refresh frequency of the low-frequency display area L is less than the data refresh frequency of the high-frequency display area H. Specifically, when a partial display screen is displayed, the data signal of the low-frequency display area L is not refreshed, and the data signal of the high-frequency display area H is refreshed. When the data signal of the low-frequency display area L is not refreshed, its data signal line port for inputting data signals is in a high-impedance state (hiz state), with no data signal being input. Therefore, the signal on the data signal line will still be the data signal input when the previous frame of data signal is input, but due to the existence of signal attenuation, the signal Source on the data signal line will gradually decrease before the next frame of data signal is written, as shown in the curve segment A in FIG. 2.

In the display frame in which the data signal in the low-frequency display area is not refreshed and the data signal in the high-frequency display area is refreshed, when the scanning signal enters the high-frequency display area from the low-frequency display area, as shown at the position of the dividing line F in FIG. 2, the data signal required by the high-frequency display area will be written on the data signal line Source, causing the signal on the data signal line Source to jump, as shown at position B in FIG. 2.

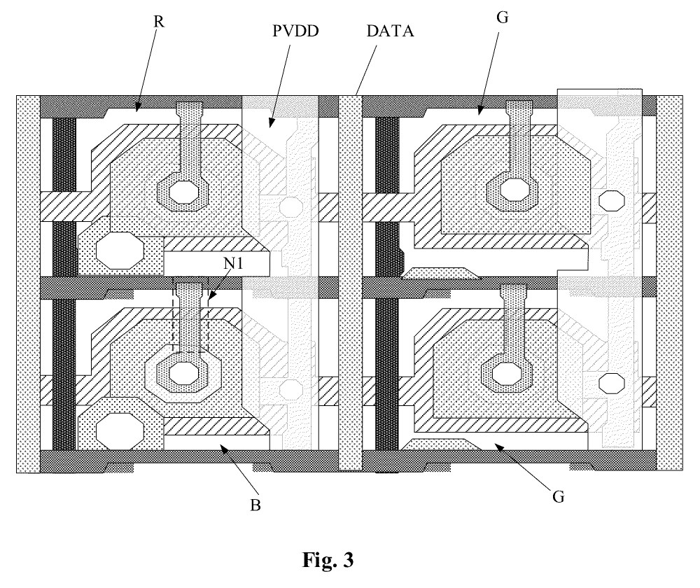

As shown in FIG. 3, in the wiring design of the display panel, the data signal line DATA and the power signal line PVDD are close to each other. Therefore, a parasitic capacitance is generated between the data signal line DATA and the power signal line PVDD. When the signal on the data signal line Source jumps, the voltage on the power signal line PVDD is pulled up due to the coupling effect of the parasitic capacitance, as shown at position C in FIG. 2.

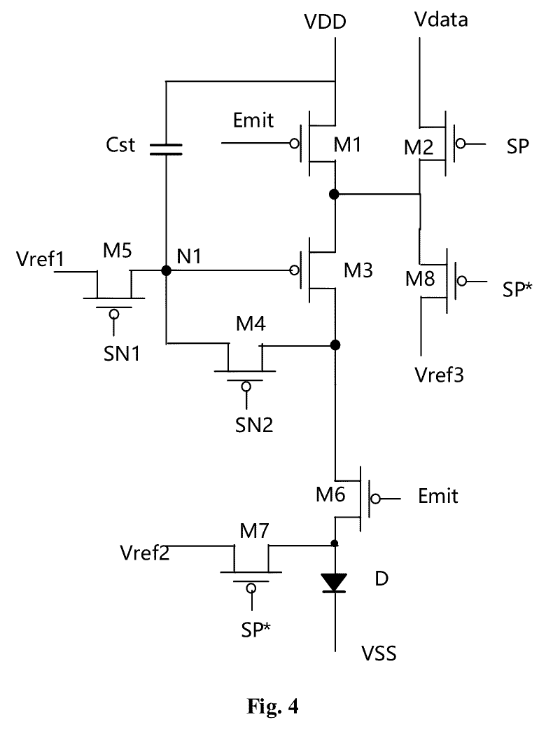

As shown in FIG. 4 which shows a schematic diagram of a circuit structure of a pixel circuit, during the specific work, the plurality of pixel circuits correspond to the display units in the display panel one by one, and are configured to control the display of the corresponding display units D. Referring to FIG. 3, in the wiring design of the display panel, there is also a parasitic capacitance between the power signal line PVDD and the N1 node of the pixel circuit. Therefore, when the voltage on the power signal line PVDD is pulled up, the potential of N1 is also pulled up, so that the potential writing of the N1 node in the pixel circuit is abnormal, thereby affecting the driving current of the display unit D, and further affecting the light-emitting brightness of the display unit D, resulting in abnormal display of the area near the low-frequency display area of the high-frequency display area of the display panel.

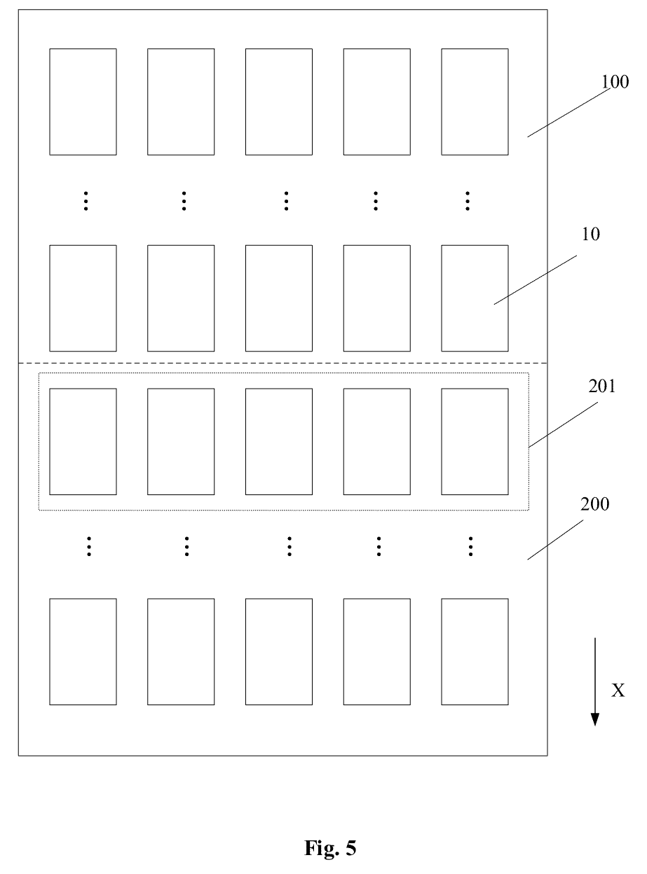

In view of this, an embodiment of the present application provides a display panel, as shown in FIG. 5, the display panel comprises:

a display array, comprising a first display area 100 and a second display area 200 arranged along a scanning direction X, a picture refresh frequency of the first display area 100 is less than a picture refresh frequency of the second display area 200, that is, relatively speaking, the first display area 100 is a low-frequency display area, and the second display area 200 is a high-frequency display area;

a plurality of pixel circuits, corresponding to the display pixels 10 in the display array one by one, and controlling the display state of the corresponding display pixels 10, the plurality of pixel circuits comprising a plurality of first pixel circuits configured to control the display state of the first row of display pixels 201 in the second display area 200 close to the first display area 100, that is, the plurality of first pixel circuits are configured to control the display state of the first row of display pixels in the high-frequency display area close to the low-frequency display area along the scanning direction;

multiple data lines DATA and multiple power lines PVDD electrically connected to the multiple pixel circuits, as shown in FIG. 3, a capacitance exists between at least one data line DATA among the multiple data lines DATA and the power line PVDD, that is, when the data signal on the data line DATA jumps, the jump signal on at least one data line DATA will couple the voltage signal on the power line PVDD, so that the voltage signal on the power line PVDD changes.

It should be noted that, in the embodiment, the display array may comprise one first display area, or may comprise at least two first display areas. Similarly, the display array may comprise one second display area, or may comprise at least two second display areas. The number of the first display areas and the second display areas may be the same or different. The present application does not impose any limitation on this, as long as the display array comprises at least one group of first display areas and second display areas arranged along the scanning direction.

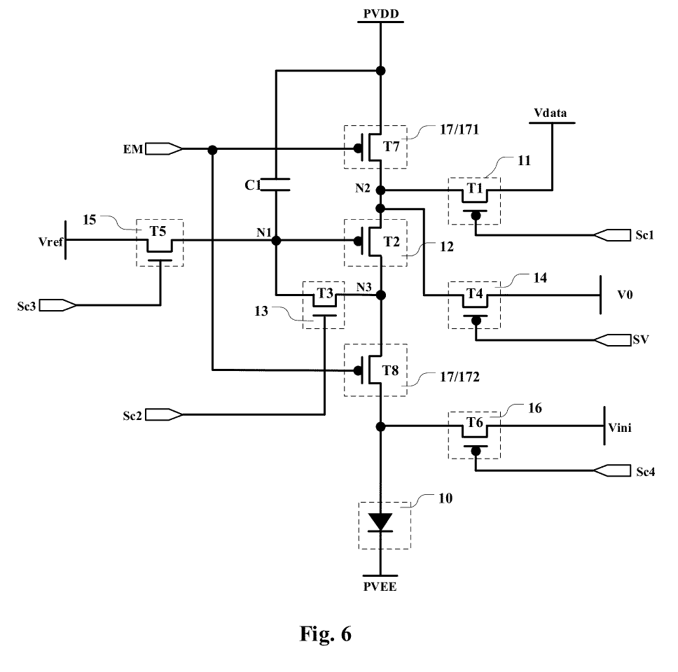

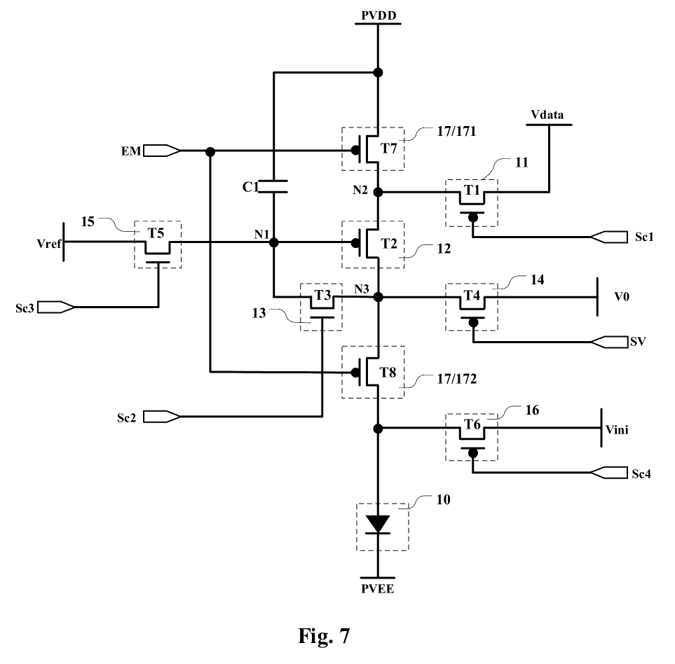

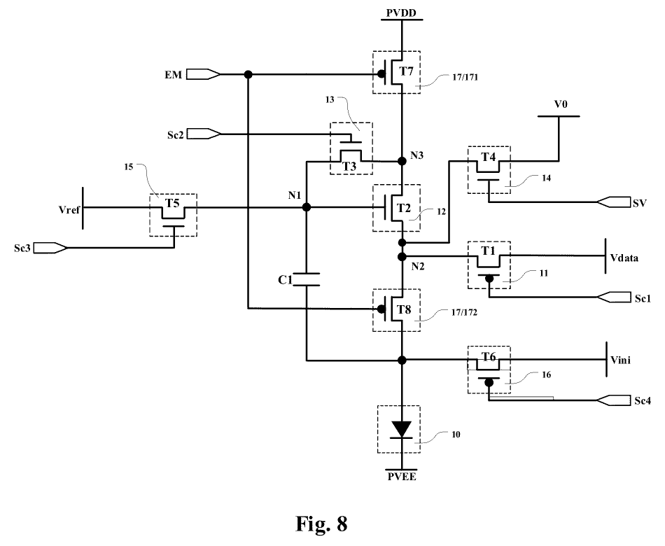

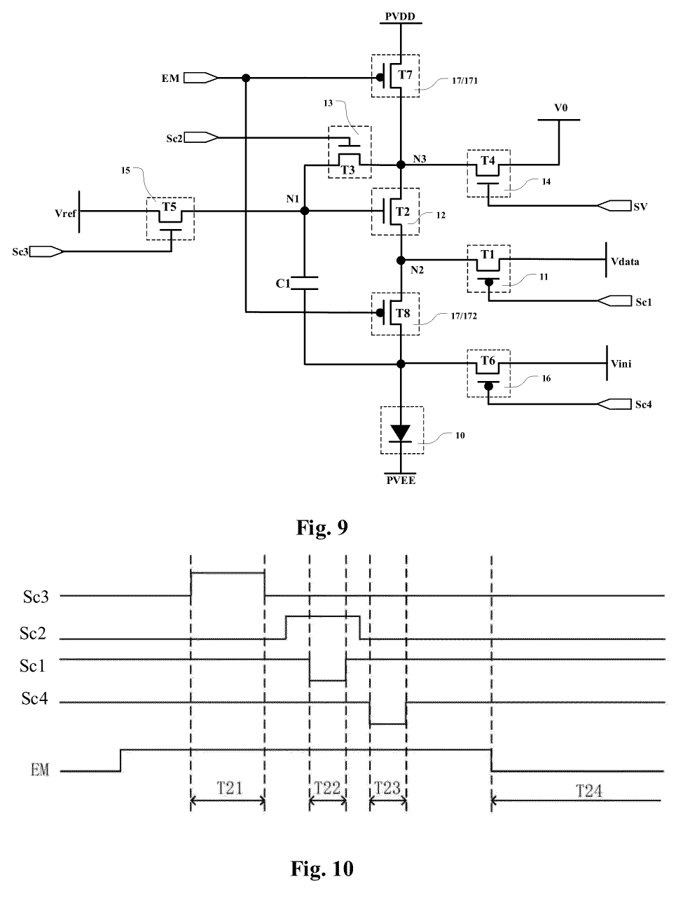

Referring to FIGS. 6 to 9, FIG. 6 is a schematic diagram of a pixel circuit in an embodiment of the present application, FIG. 7 is a schematic diagram of a pixel circuit in another embodiment of the present application, FIG. 8 is a schematic diagram of a pixel circuit in yet another embodiment of the present application, and FIG. 9 is a schematic diagram of a pixel circuit in yet another embodiment of the present application. Here, the pixel circuit comprises a data writing module 11, a driving module 12, a compensation module 13 and a bias adjustment module 14; the driving module 12 comprises a driving transistor T2 configured to provide a driving current for the display pixel 10 of the display panel; the data writing module 11 is connected to the first electrode (i.e., N2 node) of the driving transistor T2, and is configured to provide a data signal Vdata (i.e., a signal transmitted on the data line DATA ) to the driving transistor T2; the bias adjustment module 14 is connected to the first electrode (i.e., N2 node) or the second electrode (i.e., N3 node) of the driving transistor T2, and is configured to provide a bias adjustment signal V0 to the driving transistor T2; the compensation module 13 is connected between ae gate (i.e., N1 node) and the second electrode (i.e., N3 node) of the driving transistor, and is configured to compensate for the threshold voltage of the driving transistor T2.

Moreover, the pixel circuit further comprise: a reset module 15 configured to provide a reset signal Vref for the gate of the driving transistor T2; an initialization module 16 for providing an initialization signal Vini for the display pixel 10; and a light-emitting control module 17 for selectively allowing the display pixel 10 to enter a light-emitting stage. Optionally, the light-emitting control module 17 comprises a first light-emitting control module 171 and a second light-emitting control module 172. The first light-emitting control module 171 is connected between the first power signal end and one electrode of the driving transistor T2, and the second light-emitting control module 172 is connected between the other electrode of the driving transistor T2 and the display pixel 10. The display pixel 10 is connected between the output end of the pixel circuit and the second power signal end.

Optionally, in an embodiment, the control end of the data writing module 11 receives a first scanning signal Sc1, which controls the turning on and off of the data writing module 11; the control end of the compensation module 13 receives a second scanning signal Sc2, which controls the turning on and off of the compensation module 13; the control end of the bias adjustment module 14 receives a bias adjustment control signal SV, which controls the turning on and off of the bias adjustment module 14; the control end of the reset module 15 receives a third scanning signal Sc3, which controls the turning on and off of the reset module 15; the control end of the initialization module 16 receives a fourth scanning signal Sc4, which controls the turning on and off of the initialization module 16; the control end of the light-emitting control module 17 receives a light-emitting control signal EM, which controls the turning on and off of the light-emitting control module 17.

In addition, optionally, in an embodiment, the data writing module 11 comprises a data writing transistor T1, and the first scanning signal Sc1 controls the turning on and off of the data writing transistor T1; the compensation module 13 comprises a compensation transistor T3, and the second scanning signal Sc2 controls the turning on and off of the compensation transistor T3; the bias adjustment module 14 comprises a bias adjustment transistor T4, and the bias adjustment control signal SV controls the turning on and off of the bias adjustment transistor T4; the reset module 15 comprises a reset transistor T5, and the third scanning signal Sc3 controls the turning on and off of the reset transistor T5; the initialization module 16 comprises an initialization transistor T6, and the fourth scanning signal Sc4 controls the turning on and off of the initialization transistor T6; the first light-emitting control module 171 comprises a first light-emitting control transistor T7, the second light-emitting control module 172 comprises a second light-emitting control transistor T8, and the light-emitting control signal EM controls the turning on and off of the first light-emitting control transistor T7 and the second light-emitting control transistor T8.

It should be noted that, when conditions permit, at least two of the first scanning signal Sc1, the second scanning signal Sc2, the third scanning signal Sc3, the fourth scanning signal Sc4, the bias adjustment control signal SV, the light-emitting control signal EM and other signals can be the same signal. For example, when the bias adjustment transistor T4 and the initialization transistor T6 are transistors of the same type, the bias adjustment control signal SV and the fourth scanning signal Sc4 can be the same signal.

It should be noted that, as shown in FIGS. 6 and 7, the driving transistor T2 is a PMOS transistor, and the pixel circuit further comprises a storage capacitor C1, a first electrode of the storage capacitor C1 is connected to the first power signal end, and a second electrode is connected to the gate of the driving transistor T2, for storing the signal transmitted to the gate of the driving transistor T2. Here, as shown in FIG. 6, the bias adjustment module 14 is connected to the first electrode of the driving transistor T2, that is, the N2 node, as shown in FIG. 7, the bias adjustment module 14 is connected to the second electrode of the driving transistor T2, that is, the N3 node. As shown in FIGS. 8 and 9, the driving transistor T2 is an NMOS transistor, and the pixel circuit further comprises a storage capacitor C1, a first electrode of the storage capacitor C1 is connected to the display pixel 10, and a second electrode is connected to the gate of the driving transistor T2, for storing the signal transmitted to the gate of the driving transistor T2. Here, as shown in FIG. 8, the bias adjustment module 14 is connected to the first electrode of the driving transistor T2, that is, the N2 node, as shown in FIG. 9, the bias adjustment module 14 is connected to the second electrode of the driving transistor T2, that is, the N3 node.

In the above manner, a bias adjustment module 14 is provided in the pixel circuit, and is configured to provide a bias adjustment signal V0 for the driving transistor T2. Since the potential difference between the gate and the first electrode or the second electrode of the driving transistor T2 during the light emission process of the display pixel 10 may cause a bias problem, that is, when the driving transistor T2 is a PMOS transistor, when the driving transistor T2 is turned on, the gate voltage is greater than the voltage of the first electrode or the second electrode, a bias problem will occur; that is, when the driving transistor T2 is an NMOS transistor, when the driving transistor T2 is turned on, but the gate voltage is less than the voltage of the first electrode or the second electrode, a bias problem will occur. The bias problem often causes a reverse electric field to be generated inside the driving transistor T2, resulting in carrier polarization, thereby causing the threshold voltage of the driving transistor T2 to shift. The threshold voltage of the driving transistor T2 shifts, causing the driving current generated by the driving transistor T2 to be unstable, especially when the grayscale changes, flickering problems will occur. In an embodiment, by providing a bias adjustment signal V0 for the first electrode or the second electrode of the driving transistor T2, the voltage difference between the gate of the driving transistor T2 and the first electrode or the second electrode is adjusted in time to offset the bias problem and avoid the threshold voltage of the driving transistor T2 from shifting, which is helpful to reduce the flicker phenomenon.

It should be noted that FIGS. 6 to 9 only provide several exemplary settings of the bias adjustment module 14 in the pixel circuit, but do not comprise all of them. A bias adjustment signal is provided to the pixel circuit to adjust the bias state of the driving transistor T2, and various other settings of the bias adjustment module 14 that meet the limitation of the bias adjustment signal V0 in this embodiment are all within the scope of protection of the embodiments of the present application and will not be described in detail in this embodiment.

In the manners shown in FIGS. 6 to 9, the first power signal end is configured to access the high-level power signal PVDD, the second power signal end is configured to access the low-level power signal PVEE, the positive electrode of the display pixel 10 is connected to the output end of the pixel circuit, and the negative electrode is connected to the second power signal end. In other manners, the second power signal end may also be set to access the high-level power signal PVDD, the first power signal end is configured to access the low-level power signal PVEE, the negative electrode of the display pixel 10 is connected to the output end of the pixel circuit, and the positive electrode is connected to the second power signal end.

It should be noted that, in the above embodiment, the pixel circuit may comprise the bias adjustment module 14, or may not comprise the bias adjustment module 14, and the present application does not limit this, and it depends on the specific situation.

Taking an example that the first power signal end is configured to access the high-level power signal PVDD, the second power signal end is configured to access the low-level power signal PVEE, the positive electrode of the display pixel 10 is connected to the output end of the pixel circuit, and the negative electrode is connected to the second power signal end, a display panel in an embodiment of the present application is described.

In this embodiment, the working process of the pixel circuit comprises: a reset stage, a data writing stage, and a light-emitting stage. Optionally, the working process of the pixel circuit further comprises an initialization stage. Specifically, as shown in FIG. 10, the working process of the pixel circuit comprises:

the reset stage T21, in which the third scanning signal Sc3 controls the reset transistor T5 to be turned on, and the reset signal Vref is transmitted to the gate of the driving transistor T2 through the reset transistor T5 to reset the gate voltage of the driving transistor T2;

the data writing stage T22, in which the second scanning signal Sc2 controls the compensation transistor T3 to be turned on, the first scanning signal Sc1 controls the data writing transistor T1 to be turned on, and the data voltage Vdata is transmitted to the gate of the driving transistor T2 through the data writing transistor T1, the first and second electrodes of the driving transistor T2, and the compensation transistor T3, so as to compensate the gate voltage of the driving transistor T2;

the initialization stage T23, in which the fourth scanning signal Sc4 controls the second reset transistor T6 to be turned on, and the second initialization signal Vini is transmitted to the first electrode (for example, anode) of the display pixel 10 through the initialization transistor T6 to initialize the voltage of the first electrode (for example, anode) of the display pixel 10; and

the light-emitting stage T24, in which the light-emitting control signal EM controls the first light-emitting control transistor T7 and the second light-emitting control transistor T8 to be turned on, and the driving transistor M3 generates a driving current to drive the display pixel 10 to emit light for display.

It should be noted that a refresh frame of the pixel circuit may comprise at least a data writing stage T22. For example, the refresh frame of the pixel circuit may comprise a reset stage T21, a data writing stage T22, an initialization stage T23, and a light-emitting stage T24. A holding frame of the pixel circuit may comprise an initialization stage T23 and a light-emitting stage T24, and the holding frame of the pixel circuit may not comprise the reset stage T21 and the data writing stage T22.

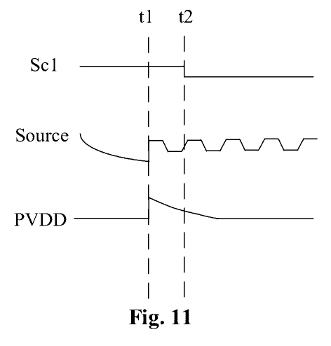

In an embodiment of the present application, in at least one first display frame, the display pixels of the first display area enter a data holding stage, and the display pixels of the second display area enter a data writing stage, that is, in the first display frame, the first display area is in a holding frame, and the second display area is in a refresh frame. In this embodiment, as shown in FIG. 11, at a first moment t1 of the first display frame, a first signal is provided to the data line, and the first moment t1 is earlier than a start moment t2 of an input writing moment of the first pixel circuit, thereby inputting the first signal to the data line electrically connected to the first pixel circuit in advance before the first pixel circuit enters the data writing stage, thereby reducing a voltage change on the power line when the first pixel circuit enters the data writing moment, reducing an abnormal potential of the N1 node in the first pixel circuit caused by the voltage change on the power line, alleviating an abnormal display phenomenon in the second display area close to the first display area, improving the display quality of the display panel, and ultimately improving the user experience.

As can be seen from FIGS. 6 to 9, the pixel circuit comprises a data writing module 11, which comprises a data writing transistor T1, that is, the pixel circuit comprises a data writing transistor T1. In the present embodiment, when a turning-on signal is input to the control end of the data writing transistor T1, the pixel circuit enters a data writing stage. Taking as an example that the data writing transistor T1 is a P-type transistor, when the signal Sc1 input to the control end of the data writing transistor T1 is a low-level signal, the data writing transistor T1 is turned on, and the voltage signal Vdata input in the data line electrically connected to the pixel circuit is input to the pixel circuit.

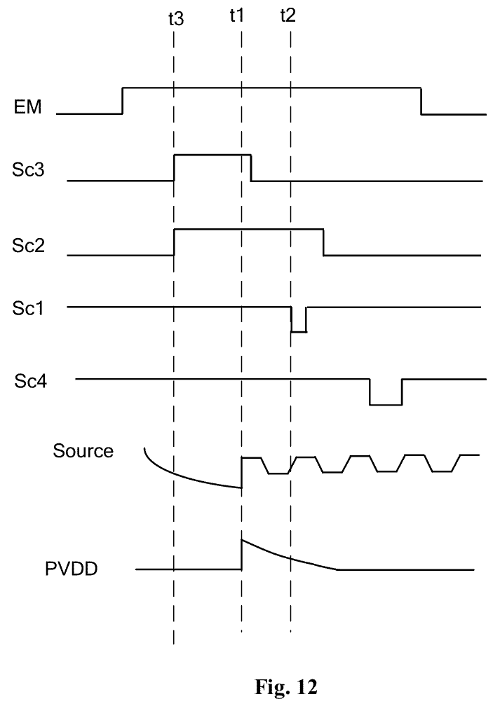

Optionally, based on the above embodiments, in an embodiment of the present application, as shown in FIG. 12, the first moment t1 is later than the start moment t3 of the reset stage of the first pixel circuit, so as to alleviate the display abnormality in the second display area close to the first display area and improve the display quality of the display panel, thereby reducing the power consumption of the display panel. However, the present application does not limit this and it depends on the specific circumstances.

As can be seen from FIGS. 6 to 9, the pixel circuit comprises a reset module 15 and a driving module 12, wherein the reset module 15 comprises a reset transistor T5, and the driving module 12 comprises a driving transistor T2, that is, the pixel circuit comprises: a driving transistor T2 and a gate reset transistor T5. In this embodiment, when a turning-on signal is input to the control end of the reset transistor T5, the pixel circuit enters a reset stage and resets the gate of the driving transistor T2. As can be seen from FIGS. 6 to 9, the pixel circuit further comprises: a compensation module 13, which comprises a compensation transistor T3; when a turning-on signal is input to the control end of the compensation transistor T3, the signal output by the data write transistor T1 is transmitted to the gate of the driving transistor T2, and the gate voltage of the driving transistor T2 is compensated.

It should be noted that, in the present embodiment, in the time period between the first moment t1 and the starting moment t2 of the data writing stage of the first pixel circuit, although the data line electrically connected to the first pixel circuit has an input first signal, the control signal of the data writing module of the first pixel circuit is a turning-off signal, the data writing module is in an turned off state, and the first signal written on the data line electrically connected to the first pixel circuit will not enter the first pixel circuit through the data writing module, and therefore will not affect the display of the display pixel corresponding to the first pixel circuit.

In addition, in actual uses, a data line usually corresponds to a column of display pixels, and the second scanning signal of other pixel circuits electrically connected to the same data line to which the first pixel circuit is connected is a turning-off signal in the time period between the first moment t1 and the start moment t2 of the data writing stage of the first pixel circuit, that is, the compensation transistor of other pixel circuit electrically connected to the same data line to which the first pixel circuit is connected is in the turning-off state in the time period between the first moment t1 and the start moment t2 of the data writing stage of the first pixel circuit. Therefore, the first signal input in advance on the data line electrically connected to the first pixel will not be written into the N1 node of other pixel circuit electrically connected to the data line, thereby not affecting the display of the display pixels corresponding to other pixel circuits electrically connected to the data line, thereby not affecting the display of the first display area.

On the basis of the above embodiments, in an embodiment of the present application, as shown in FIGS. 11 and 12, the first signal is a data voltage signal for the first pixel circuit to enter a data writing stage in the current first display frame, that is, the data voltage signal required to be input in the first pixel circuit is input into the first pixel circuit in advance, so as to alleviate the display abnormality in the second display area close to the first display area, improve the display quality of the display panel, without changing the signal input in the data line, thereby reducing the difficulty of controlling the display panel.

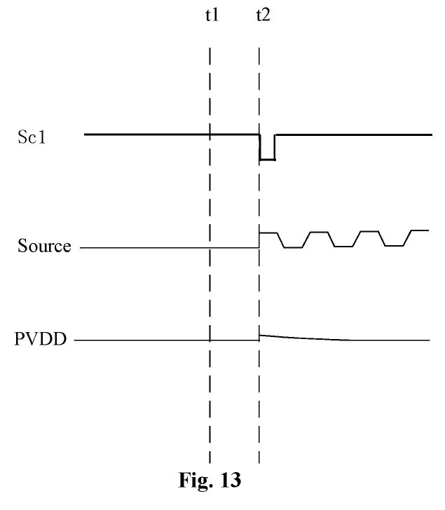

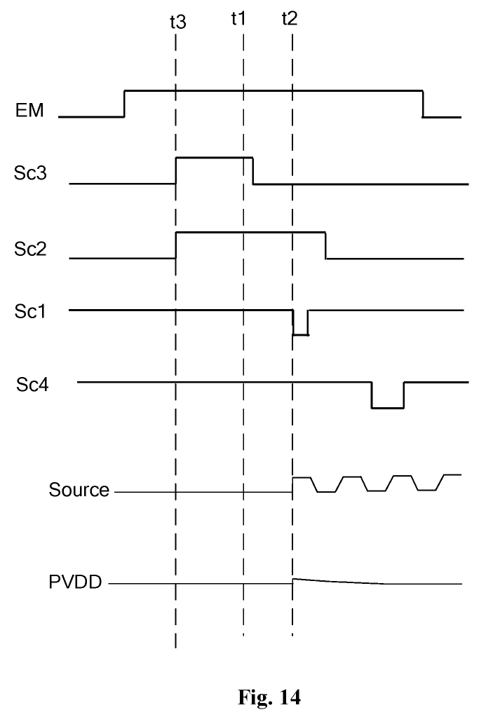

In another embodiment of the present application, as shown in FIGS. 13 and 14, the first signal is a fixed voltage signal, and the difference between the voltage value of the first signal and the maximum voltage value of the data voltage signal required when the first pixel circuit enters the data writing stage in the current first display frame is within a preset value range, that is, before the data line electrically connected to the first pixel circuit inputs the required data voltage signal, a fixed voltage signal is first input to the data line electrically connected to the first pixel circuit, thereby reducing the variation amplitude of the voltage signal on the data line electrically connected to the first pixel circuit when the first pixel circuit enters the data writing stage, and then reducing the variation amplitude of the voltage signal on the power line, so as to reduce the variation amplitude of the N1 node in the first pixel circuit, alleviate the display abnormality in the second display area close to the first display area, and improve the display quality of the display panel.

It should be noted that, since the data voltage signal required to be input into the first pixel circuit is different in different first display frames, optionally, on the basis of the above embodiment, in an embodiment of the present application, the working process of the display panel comprises multiple first display frames, and in different first display frames, the value of the first signal is not exactly the same, as long as it is sufficient to ensure that the difference between the voltage value of the first signal and the maximum voltage value of the data voltage signal required by the first pixel circuit when entering the data writing stage in the current first display frame is within a preset numerical range, so that the first signal can be determined according to the value of the data voltage signal required by the first pixel circuit in the current first display frame, so as to better reduce the variation amplitude of the voltage signal on the data line electrically connected to the first pixel circuit when entering the data writing stage, thereby reducing the variation amplitude of the voltage signal on the power line, so as to reduce the variation amplitude of the N1 node in the first pixel circuit, alleviate the display abnormality in the second display area close to the first display area, and improve the display quality of the display panel.

On the basis of the above embodiments, in an embodiment of the present application, the first display area comprises N rows of display pixels arranged along the scanning direction, and the first moment starts at the scanning moment of a (N-K)th row of the display pixels in the first display area, where N is greater than K, and K is an integer not less than 1, so as to advance the scanning time of k rows of display pixels and input a first signal to the first pixel circuit, thereby alleviating display abnormalities in a part of the second display area close to the first display area and improving the display quality of the display panel.

Optionally, in an embodiment of the present application, the value of K is in a range of 4-8, so as to alleviate the display abnormality in the second display area close to the first display area and improve the display quality of the display panel, while shortening the input time of the first signal as much as possible and reducing the power consumption of the display panel, but the present application does not limit this and it depends on the specific situation.

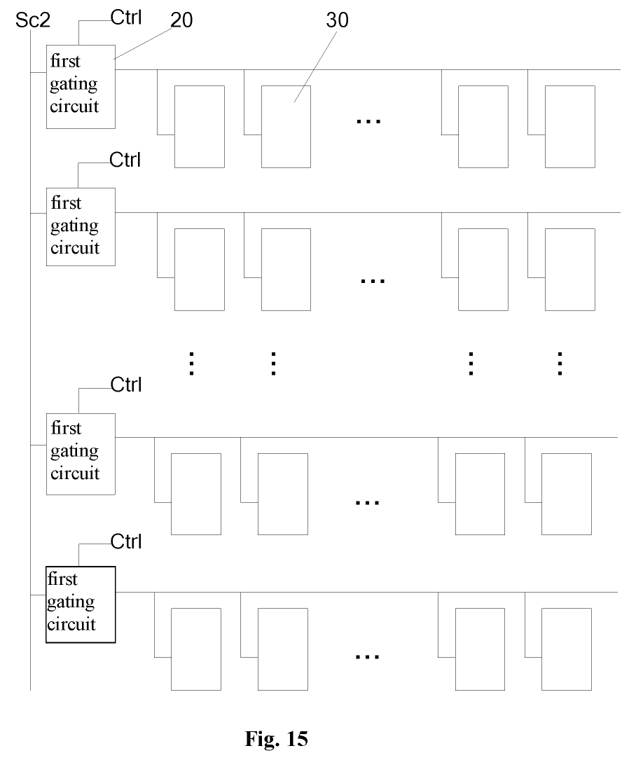

On the basis of any of the above embodiments, in an embodiment of the present application, as shown in FIG. 15, the display panel further comprises: a plurality of first gating circuits 20, one of the first gating circuits 20 being electrically connected to at least one row of the pixel circuits 30, an input end of the first gating circuit 20 being input the control signal of the compensation transistor T3 (i.e., the second scanning signal Sc2), a control end being input the first gating signal Ctrl, an output end being electrically connected to the control end of the compensation transistor T3 and being used for transmitting the control signal of the compensation transistor T3 (i.e., the second scanning signal Sc2) to the control end of the compensation transistor T3 under the control of the first gating signal Ctrl, so as to control the on and off of the compensation transistor T3.

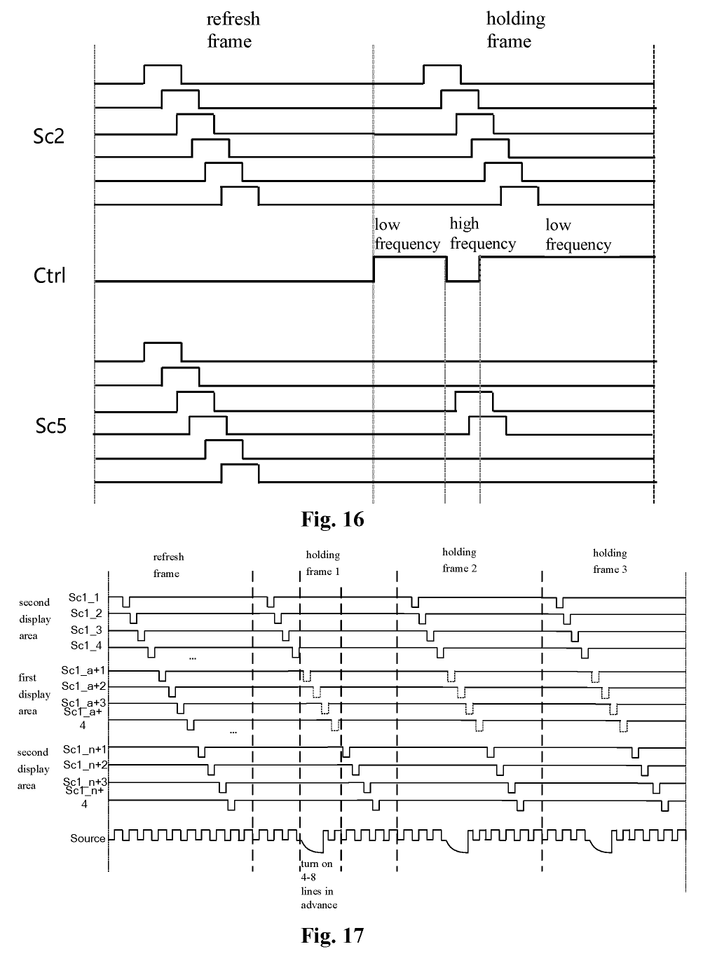

Taking an example that the first gating circuit is turned on at a low level, as shown in FIG. 16, Sc2 represents the control signal of the compensation transistor T3 input to the input end of the first gating circuit, Ctrl represents the control signal input to the control end of the first gating circuit, and Sc5 represents the signal output to the control end of the compensation transistor from the output end of the first gating circuit. It can be seen from FIG. 16 that when the control signal of the first gating circuit is at a low level, the signal Sc5 output to the control end of the compensation transistor by the first gating circuit is the same as the signal Sc2 input to the input end of the first gating circuit, and when the control signal of the first gating circuit is at a high level, the signal Sc2 input to the input end of the first gating circuit will not be transmitted to the output end of the first gating circuit to be output to the control end of the compensation transistor via the first gating circuit.

Optionally, in an embodiment of the present application, the multiple first gating circuits comprise a first sub-gating circuit and a second sub-gating circuit, the first sub-gating circuit is configured to provide the control signal of the compensation transistor to the pixel circuit corresponding to the display pixel of the first display area under the control of the first gating signal, and the second sub-gating circuit is configured to provide the control signal of the compensation transistor to the pixel circuit corresponding to the display pixel of the second display area under the control of the first gating signal; in the first display frame, the gating signal of the first sub-gating circuit is a turning-off signal, and the gating signal of the second sub-gating circuit is a turning-on signal, so that in the first display frame, the display pixels of the first display area are in a data holding stage, and the display pixels of the second display area are in a data writing stage.

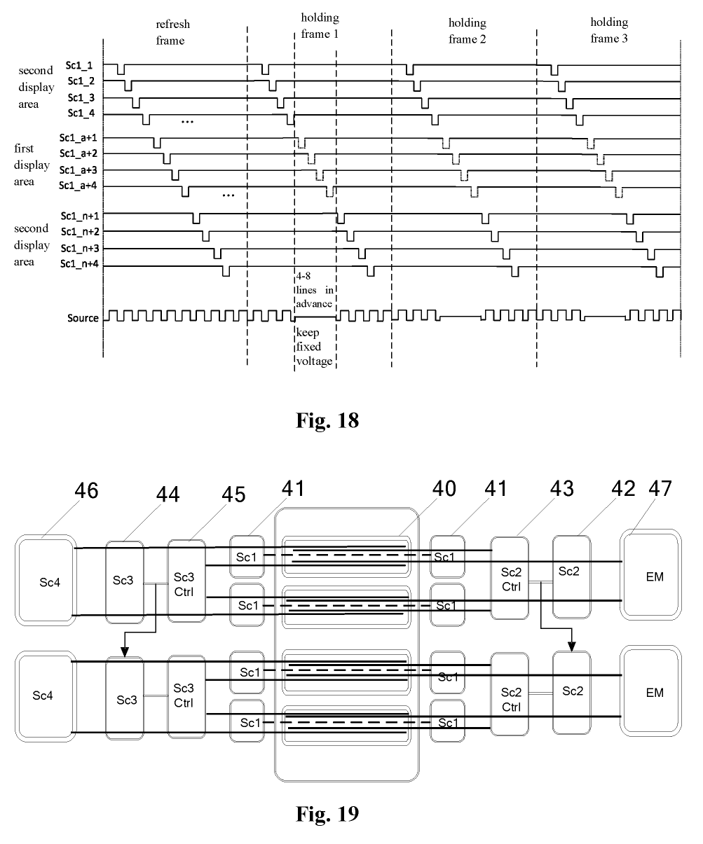

As shown in FIGS. 17 and 18, taking an example that the refresh frequency of the second display area is 4 times the refresh frequency of the first display area, Sc1_1, Sc1_2, Sc1_3, and Sc1_4 respectively represent the timing diagram of the first scanning signal (the control signal of the control end of the data writing transistor) of the pixel circuits corresponding to the first row of display pixels, the pixel circuits corresponding to the second row of display pixels, the pixel circuits corresponding to the third row of display pixels, and the pixel circuits corresponding to the fourth row of display pixels in the second display area located in front of the first display area along the scanning direction; Sc1_a+1, Sc1_a+2, Sc1_a+3, and Sc1_a+4 respectively represent the timing diagram of the first scanning signal (the control signal of the control end of the data writing transistor) of the pixel circuits corresponding to the first row of display pixels, the pixel circuits corresponding to the second row of display pixels, the pixel circuits corresponding to the third row of display pixels, and the pixel circuits corresponding to the fourth row of display pixels in the second display area located in front of the first display area along the scanning direction; Sc1_n+1, Sc1_n+2, Sc1_n+3, and Sc1_n+4 are timing diagram of the first scanning signal (control signal of the control end of the data write transistors) of the pixel circuits corresponding to the first row of display pixels, the pixel circuits corresponding to the second row of display pixels, the pixel circuits corresponding to the third row of display pixels, and the pixel circuits corresponding to the fourth row of display pixels in the second display area located behind the first display area along the scanning direction.

It can be seen from FIG. 17 and FIG. 18 that in a display cycle of the first display area, the display pixels of the first display area comprise one refresh frame and three holding frames (holding frame 1, holding frame 2, and holding frame 3), and the working process of the pixel circuits of the display pixels of the second display area comprises four refresh frames (corresponding to the stages of the refresh frame, holding frame 1, holding frame 2, and holding frame 3, respectively). It can be seen from FIG. 17 and FIG. 18 that in the stages of holding frame 1, holding frame 2, and holding frame 3, although the control end of the data writing transistor in the pixel circuit corresponding to the display pixel of the first display area is input a turning-on signal, the control signal of the first gating circuit corresponding to the pixel circuit corresponding to the display pixel of the first display area is a turning-off signal, therefore, the signal input to the data writing transistor in the pixel circuit corresponding to the display pixel of the first display area will not be written to the gate of its driving transistor, and therefore, will not affect the display of the display screen of the first display area.

On the basis of any one of the above embodiments, in an embodiment of the present application, the display panel may further comprise a plurality of second gating circuits, one of the second gating circuit being electrically connected to at least one row of the pixel circuits, an input end of the second gating circuit being input the control signal Sc3 of the reset transistor T5, a control end being input the second gating signal, an output end being electrically connected to the control end of the reset transistor T5, and being used for transmitting the control signal Sc3 of the reset transistor to the control end of the reset transistor T5 under the control of the second gating signal.

Optionally, in an embodiment of the present application, as shown in FIG. 19, the display panel comprises:

a plurality of display pixel rows 40;

a first scanning signal generating circuit 41, used for outputting a first scanning signal Sc1 to control the turning on and off of the data writing module in each pixel circuit corresponding to the display pixel row 40;

a second scanning signal generating circuit 42, used for generating a second scanning signal Sc2;

a first gating circuit 43, used for controlling the turning on and off of a path between the second scanning signal generating circuit 42 and a control end of the compensation module in each pixel circuit corresponding to the display pixel row 40;

a third scanning signal generating circuit 44, used for generating a third scanning signal Sc3;

a second gating circuit 45, configured to control the tuning on and off of a path between the third scanning signal generating circuit 44 and a control end of the reset module in each pixel circuit corresponding to the display pixel row 40;

a fourth scanning signal, generating circuit 46, configured to generate a fourth scanning signal Sc4 to control the turning on and off of the initialization module in each pixel circuit corresponding to the display pixel row 40;

a light-emitting control signal generating circuit 47, configured to generate a light-emitting control signal EM to control the turning on and off of the light-emitting control module in each pixel circuit corresponding to the display pixel row 40.

Optionally, in an embodiment of the present application, as shown in FIG. 19, one first gating circuit 43 corresponds to two rows of display pixels (i.e., corresponding to two display pixel rows 40), so as to reduce the occupied space of multiple first gating circuits in the display panel, which is conducive to the realization of a narrow frame of the display panel; similarly, one second gating circuit 45 corresponds to two rows of display pixels (i.e., corresponding to two display pixel rows 40), so as to reduce the occupied space of multiple second gating circuits in the display panel, which is conducive to the realization of a narrow frame of the display panel. However, the present application does not limit this, and it depends on the specific situation.

It should be noted that, since the first scanning signal generating circuits corresponding to different pixel rows in two display pixel rows electrically connected to a same first gating circuit are different, even if a same first gating circuit is electrically connected to two display pixel rows, it will not affect the independent display of the two display pixel rows; similarly, since the first scanning signal generating circuits corresponding to different pixel rows in two display pixel rows electrically connected to a same second gating circuit are different, even if a same second gating circuit is electrically connected to two display pixel rows, it will not affect the independent display of the two display pixel rows.

In addition, an embodiment of the present application further provides a display device, which comprises the display panel provided in any of the above embodiments. Since the description of the display panel has been described in detail in the above embodiments, it will not be repeated here. It should be noted that in the embodiment, the display device can be a device with a display function such as a mobile phone, a tablet computer, a laptop computer, etc., and this application does not limit this, and it depends on the specific situation.

In the display panel and the display device provided in embodiments of the present application, the working process of the pixel circuit comprises: a reset stage, a data writing stage and a light-emitting stage; in at least one first display frame, the display pixels of the first display area enter the data holding stage, and the display pixels of the second display area enter the data writing stage. At the first moment in the first display frame, a first signal is provided to the data line, the first moment being earlier than the start moment of the data writing stage of the first pixel circuit; therefore, by inputting the first signal into the data line electrically connected to the first pixel circuit in advance before the first pixel circuit enters the data writing stage, the voltage change on the power line is reduced when the first pixel circuit enters the data writing moment, thereby reducing the potential abnormality of the N1 node in the first pixel circuit caused by the voltage change on the power line, alleviating the display abnormality of a part of the second display area close to the first display area, improving the display quality of the display panel, and ultimately improving the user experience.

In addition, an embodiment of the present application further provides a method for driving a display panel, as shown in FIG. 5, the display panel comprising:

a display array, comprising a first display area 100 and a second display area 200 arranged along a scanning direction X, a picture refresh frequency of the first display area 100 being less than a picture refresh frequency of the second display area 200, that is, relatively speaking, the first display area 100 is a low-frequency display area, and the second display area 200 is a high-frequency display area;

a plurality of pixel circuits, corresponding to display pixels 10 in the display array one by one and controlling the display state of the corresponding display pixels 10, the pixel circuits comprising a plurality of first pixel circuits configured to control the display state of the first row of display pixels 201 in the second display area 200 close to the first display area 100, that is, the plurality of first pixel circuits is configured to control the display state of the first row of display pixels in the high-frequency display area close to the low-frequency display area along the scanning direction;

a plurality of data lines DATA and a plurality of power lines PVDD electrically connected to the pixel circuits, as shown in FIG. 3, at least one data line DATA among the plurality of data lines DATA and the power line PVDD having capacitance therebetween, that is, when the data signal on the data line DATA jumps, the jump signal on at least one data line DATA will couple the voltage signal on the power line PVDD, so that the voltage signal on the power line PVDD changes, where a working process of the pixel circuit comprises: a reset stage, a data writing stage and a light-emitting stage,

the method according to the embodiment comprising: in at least one first display frame, making the display pixels of the first display area enter the data holding stage, and making the display pixels of the second display area enter the data writing stage. That is, in the first display frame, the first display area is in a holding frame, and the second display area is in a refresh frame. In this embodiment, as still shown in FIG. 11, at the first moment t1 of the first display frame, a first signal is provided to the data line, the first moment t1 being earlier than the start moment t2 of the input writing moment of the first pixel circuit, so that by inputting the first signal to the data line electrically connected to the first pixel circuit in advance before the first pixel circuit enters the data writing stage, the voltage change on the power line is reduced when the first pixel circuit enters the data writing moment, thereby reducing the potential abnormality of the N1 node in the first pixel circuit caused by the voltage change on the power line, alleviating the display abnormality phenomenon of a part of the second display area close to the first display area, improving the display quality of the display panel, and finally improving the user experience.

Optionally, based on the above embodiments, in an embodiment of the present application, as shown in FIG. 12, the first moment t1 is later than the start moment t3 of the reset stage of the first pixel circuit, so as to alleviate the display abnormality in the second display area close to the first display area and improve the display quality of the display panel, thereby reducing the power consumption of the display panel. However, the present application does not limit this and it depends on the specific circumstances.

It should be noted that, in the present embodiment, during the time period between the first moment t1 and the starting moment t2 of the data writing stage of the first pixel circuit, although the data line electrically connected to the first pixel circuit is input an first signal, the control signal of the data writing module of the first pixel circuit is a turning-off signal, the data writing module is in an off state, and the first signal written on the data line electrically connected to the first pixel circuit will not enter the first pixel circuit through the data writing module, and therefore will not affect the display of the display pixel corresponding to the first pixel circuit.

In addition, in actual applications, a data line usually corresponds to a column of display pixels, and the second scanning signal of other pixel circuits electrically connected to a same data line with the first pixel circuit is a turning-off signal in a time period between the first moment t1 and the start moment t2 of the data writing stage of the first pixel circuit, that is, the compensation transistors of other pixel circuits electrically connected to the same data line with the first pixel circuit are in the off state in the time period between the first moment t1 and the start moment t2 of the data writing stage of the first pixel circuit, therefore, the first signal input in advance on the data line electrically connected to the first pixel will not be written into the N1 node of other pixel circuits electrically connected to the data line, thereby not affecting the display of the display pixels corresponding to other pixel circuits electrically connected to the data line, nor affecting the display of the first display area.

On the basis of the above embodiments, in an embodiment of the present application, as shown in FIGS. 11 and 12, the first signal is a data voltage signal for the first pixel circuit to enter the data writing stage in the current first display frame, that is, the data voltage signal required to be input in the first pixel circuit is input into the first pixel circuit in advance, so as to alleviate the display abnormality in the second display area close to the first display area, improve the display quality of the display panel, without changing the signal input in the data line, thereby reducing the difficulty of controlling the display panel.

In another embodiment of the present application, as shown in FIGS. 13 and 14, the first signal is a fixed voltage signal, and the difference between the voltage value of the first signal and the maximum voltage value of the data voltage signal required when the first pixel circuit enters the data writing stage in the current first display frame is within a preset value range, that is, before the data line electrically connected to the first pixel circuit is input its required data voltage signal, a fixed voltage signal is first input to the data line electrically connected to the first pixel circuit, thereby reducing the variation amplitude of the voltage signal on the data line electrically connected to the first pixel circuit when the first pixel circuit enters the data writing stage, and then reducing the variation amplitude of the voltage signal on the power line, so as to reduce the variation amplitude of the N1 node in the first pixel circuit, alleviate the display abnormality in the second display area close to the first display area, and improve the display quality of the display panel.

It should be noted that, since the data voltage signals required to be input into the first pixel circuits are different in different first display frames, optionally, on the basis of the above embodiment, in an embodiment of the present application, the working process of the display panel comprises multiple first display frames, and in different first display frames, the value of the first signal is not exactly the same as long as it is sufficient to ensure that the difference between the voltage value of the first signal and the maximum voltage value of the data voltage signal required by the first pixel circuit when entering the data writing stage in the current first display frame is within a preset numerical range, so that the first signal can be determined according to the value of the data voltage signal required by the first pixel circuit in the current first display frame, so as to better reduce the variation amplitude of the voltage signal on the data line electrically connected to the first pixel circuit when entering the data writing stage, thereby reducing the variation amplitude of the voltage signal on the power line, so as to reduce the variation amplitude of the N1 node in the first pixel circuit, alleviate the display abnormality in the second display area close to the first display area, and improve the display quality of the display panel.

On the basis of any one of the above embodiments, in an embodiment of the present application, the first display area comprises N rows of display pixels arranged along the scanning direction, and the first moment starts at the scanning moment of a (N-K)th rows of the display pixels in the first display area, where N is greater than K, and K is an integer not less than 1, so as to advance the scanning time of k rows of display pixels and input a first signal to the first pixel circuit, thereby alleviating display abnormalities in a part of the second display area close to the first display area and improving the display quality of the display panel.

Optionally, in an embodiment of the present application, the value of K is in a range of 4-8, so as to alleviate the display abnormality in the second display area close to the first display area and improve the display quality of the display panel, while shortening the input time of the first signal as much as possible and reducing the power consumption of the display panel, the present application does not limit this and it depends on the specific situation.

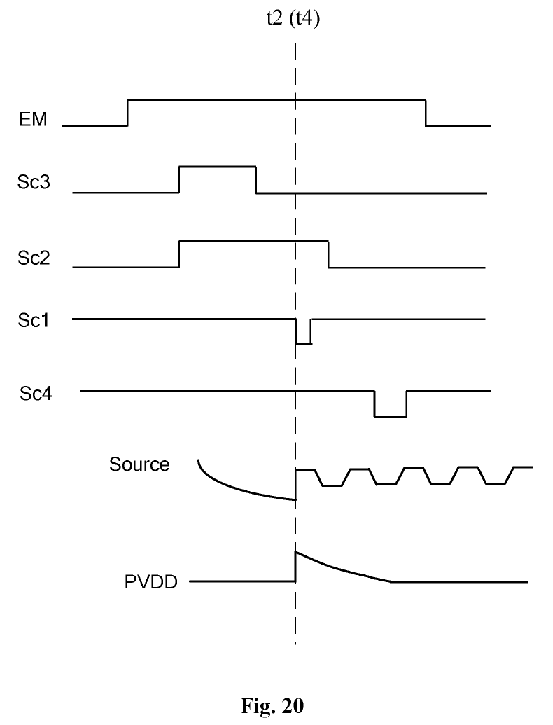

On the basis of any of the above embodiments, in an embodiment of the present application, the method further comprises: at least one second display frame, in which the display pixels of the first display area enter the data writing stage, and the display pixels of the second display area enter the data writing stage, that is, in the second display frame, the display pixels of the first display area and the display pixels of the second display area both enter the refresh frame, as shown in FIG. 20, at the second moment t4 of the second display frame, a target data voltage required by the first pixel circuit is provided to the data line, where the second moment t4 is not earlier than the start moment t2 of the data writing stage of the first pixel circuit, so as to avoid the input of the target data voltage in the first pixel circuit affecting the writing of the data voltage signal of some display pixels in the first display area, which affects the display of the first display area. Optionally, the second moment t4 is the same moment as the start moment t2 of the data writing stage of the first pixel circuit, the present application does not limit this, and it depends on the specific situation.

On the basis of any one of the above embodiments, in an embodiment of the present application, as shown in FIG. 15, the display panel further comprises: a plurality of first gating circuits 20, one of the first gating circuits 20 being electrically connected to at least one row of the pixel circuits 30, an input end of the first gating circuit 20 being input the control signal of the compensation transistor T3 (i.e., the second scanning signal Sc2), a control end being input the first gating signal Ctrl, an output end being electrically connected to the control end of the compensation transistor T3 and used for transmitting the control signal of the compensation transistor T3 (i.e., the second scanning signal Sc2) to the control end of the compensation transistor T3 under the control of the first gating signal Ctrl, so as to control the on and off of the compensation transistor T3.

Optionally, in an embodiment of the present application, the plurality of first gating circuits comprise a first sub-gating circuit and a second sub-gating circuit, the first sub-gating circuit is configured to provide the control signal of the compensation transistor to the pixel circuit corresponding to the display pixel of the first display area under the control of the first gating signal, and the second sub-gating circuit is configured to provide the control signal of the compensation transistor to the pixel circuit corresponding to the display pixel of the second display area under the control of the first gating signal; in this embodiment, the method further comprises: in the first display frame, providing a turning-off signal to the control end of the first sub-gating circuit and providing a turning-on signal to the control end of the second sub-gating circuit, so that in the first display frame, the display pixel of the first display area is in the data holding stage, and the display pixel of the second display area is in the data writing stage. The present application does not limit this, and it depends on the specific situation.

In summary, in the method for driving the display panel provided in embodiments of the present application, at a first moment in the first display frame when the display pixel of at least one of the first display areas enters the data holding stage and the display pixel of the second display area enters a data writing stage, a first signal is provided to the data line, the first moment is earlier than the start moment of the data writing stage of the first pixel circuit, thus by inputting the first signal into the data line electrically connected to the first pixel circuit in advance before the first pixel circuit enters the data writing stage, the voltage change on the power line is reduced when the first pixel circuit enters the data writing moment, thereby reducing the potential abnormality of the N1 node in the first pixel circuit caused by the voltage change on the power line, alleviating the display abnormality phenomenon in the second display area close to the first display area, improving the display quality of the display panel, and ultimately improving the user experience.

Herein, embodiments are described in a progressive, parallel, or progressive and parallel manner, embodiments focus on the differences from other embodiments, and the same or similar parts in the embodiments can be referred to each other. For the device disclosed in the embodiments, since it corresponds to the method disclosed in the embodiment, the description is relatively simple, and the relevant parts can be referred to the method.

It should be noted that in the description of the present application, it should be understood that the description of the drawings and embodiments is illustrative rather than restrictive. The same reference numerals throughout the embodiments of the specification identify the same structure. It should also be noted that, in this article, relational terms such as first and second, etc. are only configured to distinguish one entity or operation from another entity or operation, and do not necessarily require or imply that there is any such actual relationship or order between these entities or operations. Moreover, the term "comprise", "comprising" or any other variant thereof is intended to cover non-exclusive inclusion, so that the article or equipment comprising a series of elements comprises not only those elements, but also comprises other elements that are not clearly listed, or also comprises elements inherent to such articles or equipment. In the absence of more restrictions, the elements limited by the sentence "comprising a..." do not exclude the existence of other identical elements in the article or equipment comprising the above elements.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the present application. Therefore, the present application will not be limited to the embodiments shown herein, but will conform to the widest scope consistent with the principles and novel features disclosed herein.

What is claimed is:

1. A display panel, comprising:
a display array, comprising a first display area and a second display area arranged along a scanning direction, a picture refresh frequency of the first display area being less than a picture refresh frequency of the second display area;
a plurality of pixel circuits, corresponding to display pixels in the display array one by one to control display states of the respective display pixels, the plurality of pixel circuits comprising a plurality of first pixel circuits configured to control display states of a first row of the display pixels in the second display area close to the first display area;
a plurality of data lines and a plurality of power lines electrically connected with the plurality of pixel circuits, at least one of the plurality of data lines and at least one of the plurality power line having capacitance therebetween,
wherein a working process of the plurality of pixel circuits comprises a reset stage, a data writing stage and a light-emitting stage,
in at least one first display frame, display pixels of the first display area enter a data holding stage, and display pixels of the second display area enter the data writing stage, and
at the first moment in the first display frame, a first signal is provided to one of the plurality of data lines, the first moment being earlier than a start moment of the data writing stage of the plurality of first pixel circuits.

2. The display panel according to claim 1, wherein the first moment is later than a start moment of the reset stage of the plurality of first pixel circuits.

3. The display panel according to claim 1, wherein the first signal is a data voltage signal required when the plurality of first pixel circuits enter the data writing stage in a current first display frame.

4. The display panel according to claim 1, wherein the first signal is a fixed voltage signal, and a difference between a voltage value of the first signal and a maximum voltage value of a data voltage signal required when the plurality of first pixel circuits enter the data writing stage in a current first display frame is within a preset value range.

5. The display panel according to claim 4, wherein in different first display frames, values of the first signal are not all the same.

6. The display panel according to claim 1, wherein the first display area comprises N rows of the display pixels arranged along the scanning direction, and the first moment starts at a scanning moment of a (N-K)th row of the display pixels in the first display area, where K is an integer not less than 1, and N is an integer greater than K.

7. The display panel according to claim 6, wherein K is in a value range of 4-8..

8. The display panel according to claim 1, wherein the plurality of pixel circuits each comprise a data writing transistor, and
when a turning-on signal is input to a control end of the data writing transistor, the plurality of pixel circuits enter the data writing stage.

9. The display panel according to claim 8, wherein the plurality of pixel circuits each comprise: a driving transistor and a compensation transistor, and
when a turning-on signal is input to a control end of the compensation transistor, a signal output by the data writing transistor is transmitted to a gate of the driving transistor to compensate for a gate voltage of the driving transistor.

10. The display panel according to claim 9, further comprising:
a plurality of first gating circuits, each of the plurality of first gating circuits correspondingly being electrically connected to at least one row of the pixel circuits, a control signal of the compensation transistor being input to an input end of each of the plurality of first gating circuits, a first gating signal being inputting to a control end of each of the plurality of first gating circuits, an output end of each of the plurality of first gating circuits being electrically connected to the control end of the compensation transistor and being configured to transmit a control signal of the compensation transistor to the control end of the compensation transistor under the control of the first gating signal.

11. The display panel according to claim 10, wherein the plurality of first gating circuits comprise a first sub-gating circuit and a second sub-gating circuit, the first sub-gating circuit being configured to provide the control signal of the compensation transistor to the pixel circuit corresponding to the display pixel in the first display area under the control of a first gating signal, and the second sub-gating circuit being configured to provide the control signal of the compensation transistor to the pixel circuit corresponding to the display pixel in the second display area under the control of the first gating signal;
in the first display frame, the gating signal of the first sub-gating circuits is a turning-off signal, and the gating signal of the second sub-gating circuit is a turning-on signal.

12. A display device, comprising a display panel, comprising:
a display array, comprising a first display area and a second display area arranged along a scanning direction, a picture refresh frequency of the first display area being less than a picture refresh frequency of the second display area;
a plurality of pixel circuits, corresponding to display pixels in the display array one by one to control display states of corresponding display pixels, the plurality of pixel circuits comprising a plurality of first pixel circuits configured to control display states of a first row of display pixels in the second display area close to the first display area;
a plurality of data lines and a plurality of power lines electrically connected with the plurality of pixel circuits, a capacitor providing between at least one of the plurality of data lines and at least one of the plurality power line,
wherein a working process of the plurality of pixel circuits comprises a reset stage, a data writing stage and a light-emitting stage, in at least one first display frame, display pixels of the first display area enter a data holding stage, and display pixels of the second display area enter the data writing stage, at the first moment in the first display frame, a first signal is provided to the plurality of data lines, the first moment being earlier than a start moment of the data writing stage of the plurality of first pixel circuits.

13. A method for driving a display panel, the display panel comprising:
a display array, comprising a first display area and a second display area arranged along a scanning direction, a picture refresh frequency of the first display area being less than a picture refresh frequency of the second display area;
a plurality of pixel circuits, corresponding to display pixels in the display array one by one to control display states of corresponding display pixels, the plurality of pixel circuits comprising a plurality of first pixel circuits configured to control display states of a first row of display pixels in the second display area close to the first display area;
a plurality of data lines and a plurality of power lines electrically connected with the plurality of pixel circuits, a capacitor providing between at least one of the plurality of data lines and at least one of the plurality power line,
wherein a working process of the plurality of pixel circuits comprises a reset stage, a data writing stage and a light-emitting stage,
the method comprising:
in at least one first display frame, making display pixels of the first display area enter a data holding stage, and making display pixels of the second display area enter the data writing stage, and
at the first moment in the first display frame, providing a first signal to the plurality of data lines, the first moment being earlier than a start moment of the data writing stage of the plurality of first pixel circuits.

14. The driving method according to claim 13, wherein the first moment is later than a start moment of the reset stage of the plurality of first pixel circuits.

15. The driving method according to claim 13, wherein the first signal is a data voltage signal required when the plurality of first pixel circuits enter the data writing stage in a current first display frame.

16. The driving method according to claim 13, wherein the first signal is a fixed voltage signal, and a difference between a voltage value of the first signal and a maximum voltage value of a data voltage signal required when the plurality of first pixel circuits enter the data writing stage in a current first display frame being within a preset value range.

17. The driving method according to claim 13, wherein the first display area comprises N rows of display pixels arranged along the scanning direction, the first moment starts at a scanning moment of a (N-K)th row of the display pixels in the first display area, where K is an integer not less than 1, and N is an integer greater than K.

18. The driving method according to claim 17, wherein K is in a value range of 4-8..

19. The driving method according to claim 13, further comprising:
in at least one second display frame, making the display pixels of the first display area enter the data writing stage, and making the display pixels of the second display area enter the data writing stage, and at a second moment of the at least one second display frame, providing a target data voltage required by the plurality of first pixel circuits to the plurality of data lines, the second moment being no earlier than a start moment of the data writing stage of the plurality of first pixel circuits.

20. The driving method according to claim 13, wherein the display panel further comprises: a plurality of first gating circuits, each of the plurality of first gating circuits correspondingly being electrically connected to at least one row of the pixel circuits, a control signal of the compensation transistor being input to an input end of each of the plurality of first gating circuits, a first gating signal being inputting to a control end of each of the plurality of first gating circuits, an output end of each of the plurality of first gating circuits being electrically connected to the control end of the compensation transistor and being configured to transmit a control signal of the compensation transistor to the control end of the compensation transistor under the control of the first gating signal,
wherein the plurality of first gating circuits comprise a first sub-gating circuit and a second sub-gating circuit, the first sub-gating circuit being configured to provide the control signal of the compensation transistor to the pixel circuit corresponding to the display pixel in the first display area under the control of a first gating signal, and the second sub-gating circuit being configured to provide the control signal of the compensation transistor to the pixel circuit corresponding to the display pixel in the second display area under the control of the first gating signal;
the method further comprising:
in the first display frame, providing a turning-off signal to a control end of the first sub-gating circuit, and providing a turning-on signal to a control end of the second sub-gating circuit.
